(19) United States
(12) Patent Application Publication
(10) Pub. No.: US 2024/0405866 A1
(43) Pub. Date: Dec. 5, 2024

(54) OPTICAL FIBER SENSING SYSTEM, OPTICAL FIBER SENSING DEVICE, AND OPTICAL FIBER SENSING METHOD

(71) Applicant: NEC CORPORATION, Minato-ku, Tokyo (JP)

(72) Inventors: Tadayuki IWANO, Tokyo (JP); Yoshiaki AONO, Tokyo (JP); Naoto SAEKI, Tokyo (JP)

(73) Assignee: NEC CORPORATION, Minato-ku, Tokyo (JP)

(21) Appl. No.: 18/699,635

(22) PCT Filed: Oct. 29, 2021
(86) PCT No.: PCT/JP2021/040005

§ 371 Date: Apr. 9, 2024

(51) Int. Cl. H04B 10/071; H04B 10/272

(52) U.S. Cl. CPC H04B 10/071; H04B 10/272

(57) ABSTRACT

An optical fiber sensing system according to the present disclosure includes an optical fiber (10) having one end connected to an ONU (21), an optical output unit (211) configured to output pulsed light to the one end of the optical fiber (10), an optical input unit (212) configured to receive backscattered light for the pulsed light from one end of the optical fiber (10), and a detection unit (213) configured to transmit state information indicating a state around the optical fiber (10) based on the backscattered light.

### TECHNICAL FIELD

The present disclosure relates to an optical fiber sensing system, an optical fiber sensing device, and an optical fiber sensing method.

### BACKGROUND ART

In recent years, a technology called optical fiber sensing in which an optical fiber is used as a sensor to sense a state around the optical fiber has attracted attention. Specifically, in optical fiber sensing, an optical fiber sensing device outputs pulsed light to an optical fiber, receives backscattered light for the pulsed light, and senses a state around the optical fiber based on the received backscattered light.

For example, Patent Literature 1 discloses a technology for specifying an event (for example, abnormality) that has occurred around an optical fiber by performing optical fiber sensing.

Furthermore, in recent years, a passive optical network (PON) system, which is one of technologies for realizing fiber to the home (FTTH) in which an optical fiber is drawn into a user's house from a communication office building of a communication company, has also attracted attention.

For example, Patent Literature 2 discloses a PON system having a configuration in which a plurality of optical network units (ONUs) on the user side are connected to an optical line terminal (OLT) on a communication office building side via a transmission line.

### CITATION LIST

### Patent Literature

Patent Literature 1: International Patent Publication No. WO2021/070222
Patent Literature 2: Japanese Unexamined Patent Application Publication No. 2012-151737

### SUMMARY OF INVENTION

### Technical Problem

As described above, in recent years, an optical fiber sensing technology and a PON system have attracted attention. In addition, recently, it has been studied to apply the optical fiber sensing technology to the PON system to specify an event that has occurred in a residential area of a user's house or around the residential area.

As an example of a configuration in a case where the optical fiber sensing technology is applied to the PON system, for example, it is conceivable to cause an OLT on the communication office building side to function as an optical fiber sensing device and to specify an event that has occurred in a residential area or around the residential area.

However, in a case where the OLT is caused to function as an optical fiber sensing device, it is necessary to be able to identify which ONU among a plurality of ONUs has caused an event detected by the OLT.

In addition, the accuracy of optical fiber sensing depends on the distance from the optical fiber sensing device to the location where the event occurs. Therefore, in a case where the OLT is caused to function as the optical fiber sensing device, the above-described distance inevitably becomes long, and there is a possibility that the accuracy of the optical fiber sensing is lowered.

Therefore, recently, there is a demand for a technology capable of more accurately specifying an event in a residential area of a user's house or around the residential area.

Therefore, in view of the above-described problems, an object of the present disclosure is to provide an optical fiber sensing system, an optical fiber sensing device, and an optical fiber sensing method capable of more accurately specifying an event in a residential area or around the residential area.

### Solution to Problem

According to an aspect, there is provided an optical fiber sensing system including:
an optical fiber having one end connected to an optical network unit (ONU);
an optical output unit configured to output pulsed light to the one end of the optical fiber;
an optical input unit configured to receive backscattered light for the pulsed light from the one end of the optical fiber; and
a detection unit configured to transmit state information indicating a state around the optical fiber based on the backscattered light.

According to an aspect, there is provided an optical fiber sensing device including:
an optical output unit configured to output pulsed light to one end of an optical fiber having one end connected to an optical network unit (ONU);
an optical input unit configured to receive backscattered light for the pulsed light from the one end of the optical fiber; and
a detection unit configured to transmit state information indicating a state around the optical fiber based on the backscattered light.

According to an aspect, there is provided an optical fiber sensing method by an optical fiber sensing device, the optical fiber sensing method including:
an output step of outputting pulsed light to one end of an optical fiber having one end connected to an optical network unit (ONU);
a receiving step of receiving backscattered light for the pulsed light from the one end of the optical fiber; and
a transmission step of transmitting state information indicating a state around the optical fiber based on the backscattered light.

According to the above aspects, it is possible to provide an optical fiber sensing system, an optical fiber sensing device, and an optical fiber sensing method capable of more accurately specifying a residential area or an event around the residential area.

### BRIEF DESCRIPTION OF DRAWINGS

FIG. 1 is a diagram illustrating a configuration example of an optical fiber sensing system according to a first example embodiment.

FIG. 2 is a flowchart illustrating an example of a schematic operation flow of the optical fiber sensing system according to the first example embodiment.

FIG. 3 is a diagram illustrating a configuration example of an optical fiber sensing system according to a second example embodiment.

FIG. 4 is a diagram illustrating a configuration example of an optical fiber sensing system according to a third example embodiment.

FIG. 5 is a diagram illustrating a configuration example of an optical fiber sensing system according to a fourth example embodiment.

FIG. 6 is a flowchart illustrating an example of a schematic operation flow of an optical fiber sensing system according to the fourth example embodiment.

FIG. 7 is a diagram illustrating a configuration example of an optical fiber sensing system according to a fifth example embodiment.

FIG. 8 is a block diagram illustrating a hardware configuration example of a computer that implements an ONU according to an example embodiment.

### EXAMPLE EMBODIMENT

Example embodiments of the present disclosure are described below with reference to the drawings. Note that in the description and drawings to be described below, omission and simplification are made as appropriate, for clarity of description. Furthermore, in each of the drawings to be described below, the same elements are denoted by the same reference signs, and an overlapping description will be omitted as necessary.

### First Example Embodiment

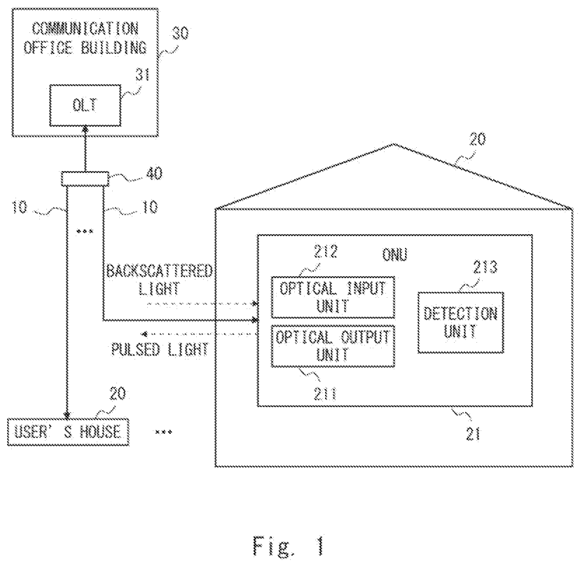

First, a configuration example of an optical fiber sensing system according to a first example embodiment will be described with reference to FIG. 1.

As illustrated in FIG. 1, the optical fiber sensing system according to the first example embodiment includes an optical fiber 10 and an ONU 21.

The ONU 21 is provided inside a user's house 20 that is a building, and is connected to an optical fiber 10.

The optical fiber 10 is realized by a PON line having one end connected to the ONU 21 provided inside the user's house 20 and the other end connected to an OLT 31 provided inside a communication office building 30.

In FIG. 1, it is assumed that there are a plurality of user's houses 20, and an optical fiber 10 connected to an OLT 31 and a plurality of optical fibers 10 connected to ONUs 21 in the plurality of user's houses 20 are connected by an optical branch 40. However, the number of user's houses 20 is not limited to a plurality, and may be one or more.

In the first example embodiment, the ONU 21 functions as an optical fiber sensing device. The ONU 21 includes an optical output unit 211 and an optical input unit 212, and further includes a detection unit 213 in order to implement the function of the optical fiber sensing device.

The optical output unit 211 outputs the pulsed light to the optical fiber 10.

The optical input unit 212 receives, from the optical fiber 10, backscattered light generated as the pulsed light output by the optical output unit 211 is transmitted through the optical fiber 10. In the first example embodiment, since the optical fiber 10 is a PON line, a communication optical signal from the OLT 31 is also transmitted. Therefore, in order to enable the optical input unit 212 to receive only the backscattered light, for example, it is preferable that a wavelength of the pulsed light output from the optical output unit 211 is shifted from the wavelength of the communication optical signal from the OLT 31, and a filter is provided at the preceding stage of the optical input unit 212.

Here, when vibration occurs around the optical fiber 10, the vibration is transmitted to the optical fiber 10, and characteristics (for example, the wavelength) of the backscattered light transmitted through the optical fiber 10 change.

Therefore, the detection unit 213 can detect the vibration generated around the optical fiber 10 based on backscattered light received from the optical fiber 10 by the optical input unit 212.

Furthermore, in a case where the detection unit 213 detects the vibration based on the backscattered light, it is possible to specify the intensity of the vibration based on the degree of change in the characteristic of the backscattered light.

In addition, the detection unit 213 can specify the location (the distance of the optical fiber 10 from the ONU 21) where the backscattered light is generated based on the time difference between the time when the optical output unit 211 outputs the pulsed light to the optical fiber 10 and the time when the optical input unit 212 receives the backscattered light from the optical fiber 10. Therefore, when the vibration is detected based on the backscattered light, the detection unit 213 can specify the location where the backscattered light is generated and specify the specified location as the generation location where the vibration is generated.

In addition, the detection unit 213 can specify the time at which vibration has occurred around the optical fiber 10.

Therefore, when vibration generated around the optical fiber 10 is detected, the detection unit 213 can acquire vibration data indicating the vibration as sensing data based on the intensity, generation location, generation time, and the like of the vibration.

In addition, even when sound is generated around the optical fiber 10, the sound is transmitted to the optical fiber 10, and the characteristics of the backscattered light transmitted through the optical fiber 10 change. In addition, even when a temperature change occurs around the optical fiber 10, the characteristics of the backscattered light transmitted through the optical fiber 10 change.

Therefore, the detection unit 213 can also detect sound and temperature generated around the optical fiber 10 based on backscattered light received from the optical fiber 10 by the optical input unit 212. In addition, when a sound generated around the optical fiber 10 is detected, the detection unit 213 can acquire acoustic data indicating the sound as sensing data. When the temperature around the optical fiber 10 is detected, the detection unit 213 can acquire temperature data indicating the temperature as sensing data.

Therefore, the detection unit 213 transmits the sensing data acquired based on the backscattered light as described above as the state information indicating the state around the optical fiber 10. The sensing data transmitted as the state information may include at least one of the vibration data, acoustic data, and temperature data. Furthermore, a transmission destination of the state information may be arbitrary, and may be, for example, a terminal of a user who owns or uses the user's house 20, a security company, a police, a fire department, or the like. In addition, the detection unit 213 may transmit the state information via a unique line or may transmit the state information via the optical fiber 10 which is a PON line. In addition, the detection unit 213 may transmit the sensing data as the state information after performing A/D conversion processing.

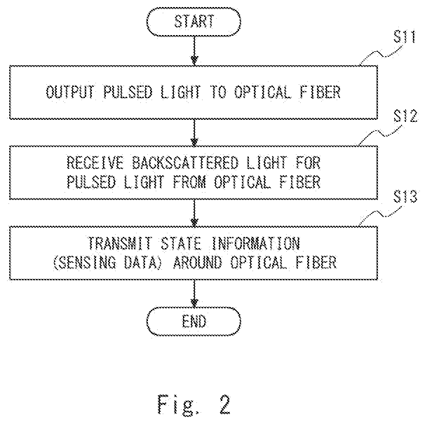

Subsequently, an example of a schematic operation flow of the optical fiber sensing system according to the first example embodiment will be described with reference to FIG. 2.

As illustrated in FIG. 2, first, the optical output unit 211 outputs pulsed light to the optical fiber 10 (Step S11).

Next, the optical input unit 212 receives, from the optical fiber 10, backscattered light for the pulsed light output by the optical output unit 211 (Step S12).

Thereafter, the detection unit 213 acquires sensing data based on the backscattered light received by the optical input unit 212, and transmits the acquired sensing data as state information indicating a state around the optical fiber 10 (Step S13). The sensing data may include at least one of the vibration data, acoustic data, and temperature data.

As described above, according to the first example embodiment, the ONU 21 outputs the pulsed light to the optical fiber 10 and receives the backscattered light from the optical fiber 10, and transmits sensing data based on the backscattered light as state information indicating a state around the optical fiber 10.

That is, according to the first example embodiment, the ONU 21 senses the state around the optical fiber 10, and transmits the sensing data as the state information. Therefore, in the transmission destination of the state information, it is possible to more accurately specify the event in the residential area of the user's house 20 or around the residential area.

### Second Example Embodiment

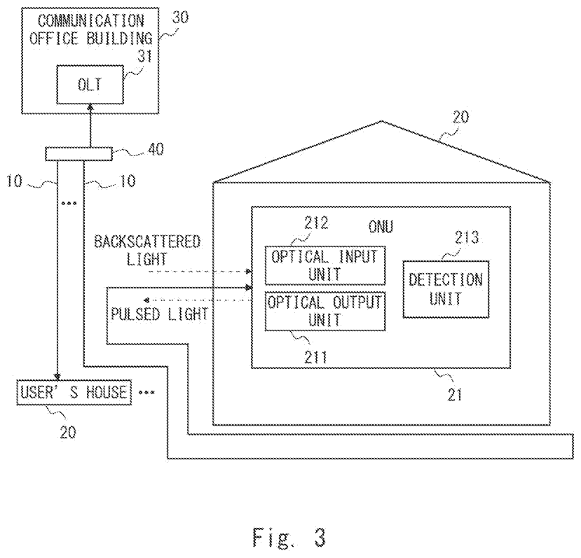

Next, a configuration example of an optical fiber sensing system according to a second example embodiment will be described with reference to FIG. 3.

As illustrated in FIG. 3, the optical fiber sensing system according to the second example embodiment is different from the above-described first example embodiment in that an optical fiber 10 that is a PON line is routed to surround the periphery of a residential area of a user's house 20 and then connected to an ONU 21.

According to the second example embodiment, since the optical fiber 10 as a PON line is laid so as to surround the periphery of the residential area of the user's house 20, it is possible to detect the event in the residential area of the user's house 20 or around the residential area in more detail as compared with the first example embodiment described above.

Note that the second example embodiment is different from the first example embodiment described above only in the method of laying the optical fiber 10 that is the PON line, and the other configurations are similar. Therefore, in the second example embodiment, the operation and effects other than the effects described above are similar to those in the first example embodiment described above, and thus the description thereof will be omitted.

### Third Example Embodiment

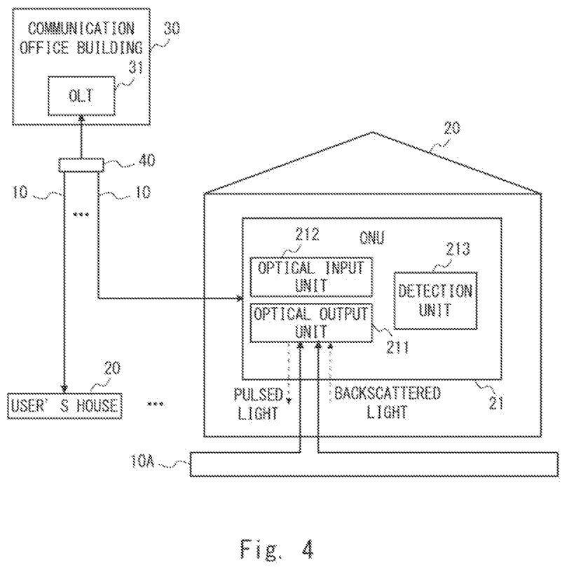

Next, a configuration example of an optical fiber sensing system according to a third example embodiment will be described with reference to FIG. 4.

As illustrated in FIG. 4, the optical fiber sensing system according to the third example embodiment is different from the first example embodiment described above in that an optical fiber 10A dedicated to sensing is provided and sensing is performed using the optical fiber 10A, and the optical fiber 10A is routed to surround the periphery of the residential area of the user's house 20 and then connected to an ONU 21.

According to the second example embodiment, since sensing is performed using the optical fiber 10A dedicated to sensing, it is not necessary to provide a filter at a preceding stage of the optical input unit 212 and to enable the optical input unit 212 to receive only backscattered light, for example, as compared with the first example embodiment described above. In addition, since the optical fiber 10A is laid so as to surround the periphery of the residential area of the user's house 20, the event in the residential area of the user's house 20 or around the residential area can be detected in more detail as compared with the above-described first example embodiment.

Note that the third example embodiment is different from the first example embodiment described above only in the optical fiber 10A used for sensing and the method for laying the optical fiber 10A, and the other configurations are similar. Therefore, in the third example embodiment, the operation and effects other than the effects described above are similar to those of the first example embodiment described above, and thus the description thereof will be omitted.

### Fourth Example Embodiment

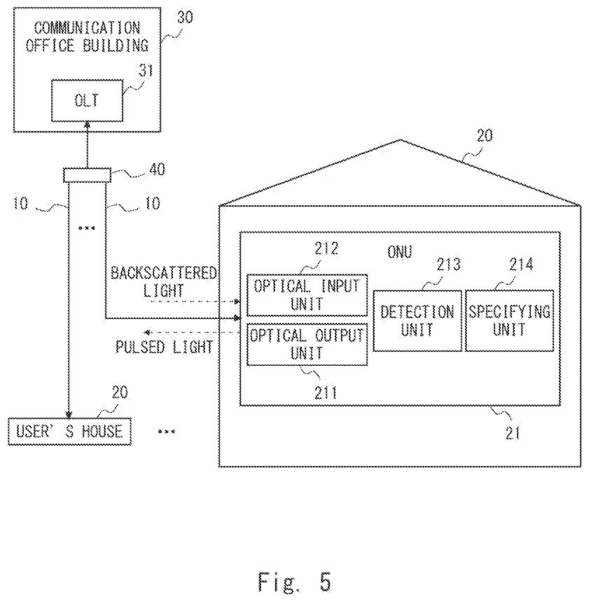

Next, a configuration example of an optical fiber sensing system according to a fourth example embodiment will be described with reference to FIG. 5.

As illustrated in FIG. 5, the optical fiber sensing system according to the fourth example embodiment is different from the first example embodiment described above in that a specifying unit 214 is added to an ONU 21.

Here, when an event (for example, abnormality or the like) involving vibration occurs around the optical fiber 10, vibration according to the event is transmitted to the optical fiber 10, and characteristics (for example, intensity) of the backscattered light transmitted through the optical fiber 10 change.

Therefore, the vibration data acquired by the detection unit 213 based on the backscattered light includes a unique vibration pattern in which the intensity of vibration, the vibration location, the transition of the fluctuation of the frequency, and the like are different according to the event. Therefore, by analyzing the dynamic change of the vibration pattern included in the vibration data, it is possible to specify the event that has caused the vibration.

In addition, even in a case where an event involving sound occurs around the optical fiber 10, the sound according to the event is transmitted to the optical fiber 10, and the characteristics of the backscattered light transmitted through the optical fiber 10 change. Therefore, the acoustic data acquired by the detection unit 213 based on the backscattered light includes a unique acoustic pattern according to the event.

In addition, when an event involving a temperature change occurs around the optical fiber 10, the characteristics of the backscattered light transmitted through the optical fiber 10 also change. Therefore, the temperature data acquired by the detection unit 213 based on the backscattered light includes a unique temperature pattern corresponding to the event.

Therefore, the specifying unit 214 specifies, by the detection unit 213, an event having occurred in the residential area of the user's house 20 or around the residential area based on the sensing data acquired based on the backscattered light. Specifically, the specifying unit 214 specifies the event that has occurred in the residential area or around the residential area by using any of the following methods. An example in which vibration data is used as the sensing data will be described below.

### (A) Method A

For each event to be specified, the specifying unit 214 stores in advance, as a matching pattern, a vibration pattern included in vibration data of vibration actually generated when the event occurs in a memory (not illustrated) or the like.

First, the detection unit 213 acquires vibration data based on the backscattered light received from the optical fiber 10 by the optical input unit 212.

Subsequently, the specifying unit 214 compares the vibration pattern included in the vibration data acquired by the detection unit 213 with the matching pattern. In a case where there is a matching pattern in which the matching rate with the vibration pattern is equal to or more than the threshold value among the matching patterns, the specifying unit 214 determines that an event corresponding to the matching pattern has occurred in the residential area of the user's house 20 or around the residential area.

### (B) Method B

The specifying unit 214 prepares, for each event to be specified, a set of teacher data indicating the event and a vibration pattern included in vibration data of vibration actually generated when the event occurs, and inputs each set thus prepared to construct in advance a learning model by a convolutional neural network (CNN) and store in advance the learning model in a memory (not illustrated) or the like.

First, the detection unit 213 acquires vibration data based on the backscattered light received from the optical fiber 10 by the optical input unit 212.

Subsequently, the specifying unit 214 inputs the vibration pattern included in the vibration data acquired by the detection unit 213 to the learning model. As a result, the specifying unit 214 obtains information on an event that has occurred in the residential area of the user's house 20 or around the residential area as an output result of the learning model.

When the specifying unit 214 specifies the event having occurred in the residential area of the user's house 20 or around the residential area, the detection unit 213 transmits a specification result of the event having occurred in the residential area of the user's house 20 or around the residential area as state information indicating a state around the optical fiber 10.

In FIG. 5, similarly to the first example embodiment in FIG. 1, sensing is performed using the optical fiber 10 that is a PON line, and the method for laying the optical fiber 10 is also similar to that in FIG. 1, but the method is not limited thereto. Similarly to the second example embodiment in FIG. 3, the optical fiber 10 that is the PON line may be laid so as to surround the periphery of the residential area of the user's house 20. Alternatively, similarly to the third example embodiment in FIG. 4, sensing may be performed using the optical fiber 10A dedicated to sensing, and the method of laying the optical fiber 10A may be similar to that in FIG. 4.

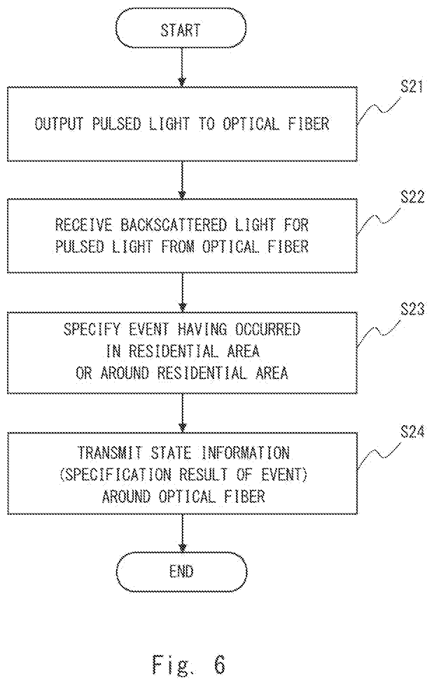

Subsequently, an example of a schematic operation flow of the optical fiber sensing system according to the fourth example embodiment will be described with reference to FIG. 6.

As illustrated in FIG. 6, first, processing in Steps S21 and S22 similar to Steps S11 and S12 in FIG. 2 is performed.

Next, the detection unit 213 acquires the sensing data based on the backscattered light received by the optical input unit 212, and the specifying unit 214 specifies the event having occurred in the residential area of the user's house 20 or around the residential area based on the sensing data acquired by the detection unit 213 (Step S23). The specification of the event may be performed using any one of the method A and the method B described above.

Thereafter, the detection unit 213 transmits, as the state information indicating the state of the periphery of the optical fiber 10, the specification result of the event having occurred in the residential area of the user's house 20 or around the residential area specified by the specifying unit 214 (Step S24).

As described above, according to the fourth example embodiment, the event that has occurred in the residential area of the user's house 20 or around the residential area is specified based on sensing data obtained by sensing the state around the optical fiber 10 on the ONU 21 side, and the specification result of the event is transmitted as state information indicating the state around the optical fiber 10. Therefore, on the ONU 21 side, it is possible to more accurately specify the event that has occurred in the residential area of the user's house 20 or around the residential area. In addition, in the transmission destination of the state information, it is possible to obtain a more accurate event specification result.

### Fifth Example Embodiment

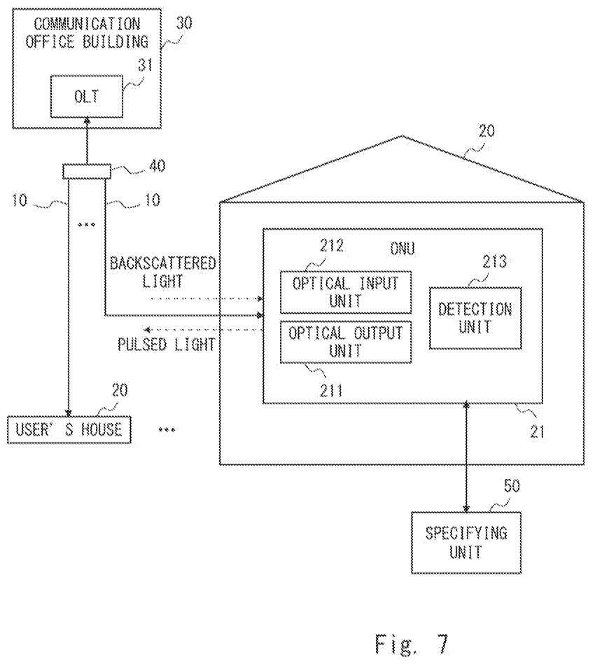

Next, a configuration example of an optical fiber sensing system according to a fifth example embodiment will be described with reference to FIG. 7.

As illustrated in FIG. 7, the optical fiber sensing system according to the fifth example embodiment is different from the fourth example embodiment described above in that the specifying unit 50 having a function similar to that of the specifying unit 214 provided in the ONU 21 inside the user's house 20 is provided outside the user's house 20.

As described above, the specifying unit 50 has the same function as the specifying unit 214 according to the above-described fourth example embodiment. That is, the specifying unit 50 has a function of specifying, by the detection unit 213, the event having occurred in the residential area of the user's house 20 or around the residential area based on the sensing data acquired based on the backscattered light.

Therefore, when the state information indicating a state around the optical fiber 10 is transmitted, the detection unit 213 first acquires the sensing data based on backscattered light, and transmits the acquired sensing data to the specifying unit 50. Then, as a response to the sensing data, the detection unit 213 receives, from the specifying unit 50, the specification result of the event that has occurred in the residential area of the user's house 20 or around the residential area, and transmits the received specification result as the state information. Note that the detection unit 213 may use a unique line or the optical fiber 10 that is the PON line for communication with the specifying unit 50. The detection unit 213 may transmit the sensing data to the specifying unit 50 after performing A/D conversion processing on the sensing data.

According to the fifth example embodiment, since the specifying unit 50 having a large processing load is provided outside the user's house 20, the processing load of the ONU 21 can be reduced as compared with the above-described fourth example embodiment.

Note that the fifth example embodiment is different from the above-described fourth example embodiment only in that the specifying unit 50 is provided outside the user's house 20, and the other configurations are similar. Therefore, in the fifth example embodiment, the operation and effects other than the effects described above are similar to those in the fourth example embodiment described above, and thus the description thereof will be omitted.

### Another Example Embodiment

In the above-described example embodiment, the optical output unit 211, the optical input unit 212, and the detection unit 213 are provided inside the ONU 21, but the present invention is not limited thereto. For example, even when the optical output unit 211 is provided outside the ONU 21, it is sufficient that the optical output unit outputs pulsed light to one end of the optical fiber 10 connected to the ONU 21. In addition, even when the optical input unit 212 is provided outside the ONU 21, it is sufficient that the optical input unit receives the backscattered light from one end of the optical fiber 10 connected to the ONU 21.

### <Hardware Configuration of ONU (Optical Fiber Sensing Device)>

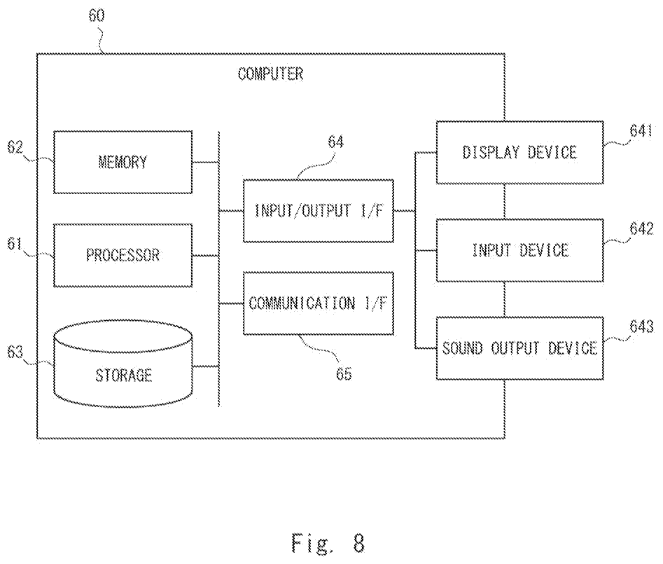

Next, a hardware configuration example of a computer 60 that implements the ONU (optical fiber sensing device) 21 according to the above-described example embodiment will be described with reference to FIG. 8.

As illustrated in FIG. 8, the computer 60 includes a processor 61, a memory 62, a storage 63, an input/output interface (input/output I/F) 64, a communication interface (communication I/F) 65, and the like. The processor 61, the memory 62, the storage 63, the input/output interface 64, and the communication interface 65 are connected by a data transmission path for mutually transmitting and receiving data.

The processor 61 is an arithmetic processing unit such as a central processing unit (CPU) or a graphics processing unit (GPU). The memory 62 is, for example, a memory such as a random access memory (RAM) or a read only memory (ROM). The storage 63 is, for example, a storage device such as a hard disk drive (HDD), a solid state drive (SSD), or a memory card. Furthermore, the storage 63 may be a memory such as a RAM or a ROM.

A program is stored in the storage 63. This program includes a command group (or software code) for causing the computer 60 to perform one or more functions in the ONU 21 described above when read by the computer. The optical output unit 211, the optical input unit 212, the detection unit 213, and the specifying unit 214 in the ONU 21 described above may be implemented by the processor 61 reading and executing a program stored in the storage 63. Furthermore, the storage function in the ONU 21 described above may be implemented by the memory 62 or the storage 63.

Furthermore, the above-described program may be stored in a non-transitory computer-readable medium or a tangible storage medium. As an example and not by way of limitation, the computer readable medium or the tangible storage medium includes a RAM, a ROM, a flash memory, an SSD or other memory technology, a compact disc (CD)-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer readable medium or a communication medium. As an example and not by way of limitation, the transitory computer readable medium or the communication medium includes an electrical signal, an optical signal, an acoustic signal, or other forms of propagation signals.

The input/output interface 64 is connected to the display device 641, the input device 642, the sound output device 643, and the like. The display device 641 is a device that displays a screen corresponding to drawing data processed by the processor 61, such as a liquid crystal display (LCD), a cathode ray tube (CRT) display, or a monitor. The input device 642 is a device that receives an operation input of an operator, and is, for example, a keyboard, a mouse, a touch sensor, or the like. The display device 641 and the input device 642 may be integrated and implemented as a touch panel. The sound output device 643 is an apparatus that acoustically outputs a sound corresponding to acoustic data processed by the processor 61, such as a speaker.

The communication interface 65 transmits and receives data to and from an external device. For example, the communication interface 65 communicates with an external device via a wired communication path or a wireless communication path.

The present disclosure has been described above with reference to the example embodiments, but the present disclosure is not limited to the example embodiments described above. Various modifications that could be understood by those skilled in the art can be made to the configuration and details of the present disclosure within the scope of the present disclosure.

For example, some or all of the above-described example embodiments may be used in combination with each other.

In addition, some or all of the above-described example embodiments may be described in the appendix below, but are not limited thereto.

### (Supplementary Note 1)

An optical fiber sensing system including:
an optical fiber having one end connected to an optical network unit (ONU);
an optical output unit configured to output pulsed light to the one end of the optical fiber;
an optical input unit configured to receive backscattered light for the pulsed light from the one end of the optical fiber; and
a detection unit configured to transmit state information indicating a state around the optical fiber based on the backscattered light.

### (Supplementary Note 2)

The optical fiber sensing system according to Supplementary Note 1, in which the detection unit transmits the state information via a passive optical network (PON) line.

### (Supplementary Note 3)

The optical fiber sensing system according to Supplementary Note 2, in which the optical fiber is the PON line.

### (Supplementary Note 4)

The optical fiber sensing system according to Supplementary Note 1 or 2, in which the optical fiber is an optical fiber dedicated to sensing.

### (Supplementary Note 5)

The optical fiber sensing system according to any one of Supplementary Notes 1 to 4, in which the optical fiber is laid so as to surround a periphery of a residential area of a building in which the ONU is provided.

### (Supplementary Note 6)

The optical fiber sensing system according to any one of Supplementary Notes 1 to 5, in which the detection unit acquires sensing data indicating a state around the optical fiber based on the backscattered light, and transmits the sensing data as the state information.

### (Supplementary Note 7)

The optical fiber sensing system according to any one of Supplementary Notes 1 to 5, in which
the detection unit acquires sensing data indicating a state around the optical fiber based on the backscattered light,
the optical fiber sensing system further includes a specifying unit configured to specify an event having occurred in a residential area or around a residential area of a building in which the ONU is provided based on the sensing data, and
the detection unit transmits a specification result of the event by the specifying unit as the state information.

### (Supplementary Note 8)

An optical fiber sensing device including:
an optical output unit configured to output pulsed light to one end of an optical fiber having one end connected to an optical network unit (ONU);
an optical input unit configured to receive backscattered light for the pulsed light from the one end of the optical fiber; and
a detection unit configured to transmit state information indicating a state around the optical fiber based on the backscattered light.

### (Supplementary Note 9)

The optical fiber sensing device according to Supplementary Note 8, in which the detection unit transmits the state information via a passive optical network (PON) line.

### (Supplementary Note 10)

The optical fiber sensing device according to Supplementary Note 9, in which the optical fiber is the PON line.

### (Supplementary Note 11)

The optical fiber sensing device according to Supplementary Note 8 or 9, in which the optical fiber is an optical fiber dedicated to sensing.

### (Supplementary Note 12)

The optical fiber sensing device according to any one of Supplementary Notes 8 to 11, in which the optical fiber is laid so as to surround a periphery of a residential area of a building in which the ONU is provided.

### (Supplementary Note 13)

The optical fiber sensing device according to any one of Supplementary Notes 8 to 12, in which the detection unit acquires sensing data indicating a state around the optical fiber based on the backscattered light, and transmits the sensing data as the state information.

### (Supplementary Note 14)

The optical fiber sensing device according to any one of Supplementary Notes 8 to 12, in which
the detection unit acquires sensing data indicating a state around the optical fiber based on the backscattered light,
the optical fiber sensing device further includes a specifying unit configured to specify an event having occurred in a residential area or around a residential area of a building in which the ONU is provided based on the sensing data, and
the detection unit transmits a specification result of the event by the specifying unit as the state information.

### (Supplementary Note 15)

An optical fiber sensing method by an optical fiber sensing device, the optical fiber sensing method including:
an output step of outputting pulsed light to one end of an optical fiber having one end connected to an optical network unit (ONU);
a receiving step of receiving backscattered light for the pulsed light from the one end of the optical fiber; and
a transmission step of transmitting state information indicating a state around the optical fiber based on the backscattered light.

### (Supplementary Note 16)

The optical fiber sensing method according to Supplementary Note 15, in which in the transmission step, the state information is transmitted via a passive optical network (PON) line.

### (Supplementary Note 17)

The optical fiber sensing method according to Supplementary Note 16, in which the optical fiber is the PON line.

### (Supplementary Note 18)

The optical fiber sensing method according to Supplementary Note 15 or 16, in which the optical fiber is an optical fiber dedicated to sensing.

### (Supplementary Note 19)

The optical fiber sensing method according to any one of Supplementary Notes 15 to 18, in which the optical fiber is laid so as to surround a periphery of a residential area of a building in which the ONU is provided.

### (Supplementary Note 20)

The optical fiber sensing method according to any one of Supplementary Notes 15 to 19, further including a step of acquiring sensing data indicating a state around the optical fiber based on the backscattered light,
in which in the transmission step, the sensing data is transmitted as the state information.

### (Supplementary Note 21)

The optical fiber sensing method according to any one of Supplementary

Notes 15 to 19, further including:
a step of acquiring sensing data indicating a state around the optical fiber based on the backscattered light; and
a step of specifying, based on the sensing data, an event that has occurred on a residential area or around a residential area of a building in which the ONU is provided,
in which in the transmission step, a specification result of the event is transmitted as the state information.

### REFERENCE SIGNS LIST

10 OPTICAL FIBER
20 USER'S HOUSE
21 ONU
211 OPTICAL OUTPUT UNIT
212 OPTICAL INPUT UNIT
213 DETECTION UNIT
214 SPECIFYING UNIT
30 COMMUNICATION OFFICE BUILDING
31 OLT
40 OPTICAL BRANCH
50 SPECIFYING UNIT
60 COMPUTER
61 PROCESSOR
62 MEMORY
63 STORAGE
64 INPUT/OUTPUT INTERFACE
64 DISPLAY DEVICE
642 INPUT DEVICE
643 SOUND OUTPUT DEVICE
65 COMMUNICATION INTERFACE

What is claimed is:

1. An optical fiber sensing system comprising:
an optical fiber having one end connected to an optical network unit (ONU);
at least one memory storing instructions, and
at least one processor configured to execute the instructions to;
output pulsed light to the one end of the optical fiber;
receive backscattered light for the pulsed light from the one end of the optical fiber; and
transmit state information indicating a state around the optical fiber based on the backscattered light.

2. The optical fiber sensing system according to claim 1, wherein the at least one processor is further configured to execute the instructions to transmit the state information via a passive optical network (PON) line.

3. The optical fiber sensing system according to claim 2, wherein the optical fiber is the PON line.

4. The optical fiber sensing system according to claim 1, wherein the optical fiber is an optical fiber dedicated to sensing.

5. The optical fiber sensing system according to claim 1, wherein the optical fiber is laid so as to surround a periphery of a residential area of a building in which the ONU is provided.

6. The optical fiber sensing system according to claim 1, wherein the at least one processor is further configured to execute the instructions to acquire sensing data indicating a state around the optical fiber based on the backscattered light, and transmits the sensing data as the state information.

7. The optical fiber sensing system according to claim 1, wherein
the at least one processor is further configured to execute the instructions to acquire sensing data indicating a state around the optical fiber based on the backscattered light,
specify an event having occurred in a residential area or around a residential area of a building in which the ONU is provided based on the sensing data, and
transmit a specification result of the event as the state information.

8. An optical fiber sensing device comprising:
at least one memory storing instructions, and
at least one processor configured to execute the instructions to;
output pulsed light to one end of an optical fiber having one end connected to an optical network unit (ONU);
receive backscattered light for the pulsed light from the one end of the optical fiber; and
transmit state information indicating a state around the optical fiber based on the backscattered light.

9. The optical fiber sensing device according to claim 8, wherein the at least one processor is further configured to execute the instructions to transmit the state information via a passive optical network (PON) line.

10. The optical fiber sensing device according to claim 9, wherein the optical fiber is the PON line.

11. The optical fiber sensing device according to claim 8, wherein the optical fiber is an optical fiber dedicated to sensing.

12. The optical fiber sensing device according to claim 8, wherein the optical fiber is laid so as to surround a periphery of a residential area of a building in which the ONU is provided.

13. The optical fiber sensing device according to claim 8, wherein the at least one processor is further configured to execute the instructions to acquire sensing data indicating a state around the optical fiber based on the backscattered light, and transmit the sensing data as the state information.

14. The optical fiber sensing device according to claim 8, wherein
the at least one processor is further configured to execute the instructions to
acquire sensing data indicating a state around the optical fiber based on the backscattered light,
specify an event having occurred in a residential area or around a residential area of a building in which the ONU is provided based on the sensing data, and
transmit a specification result of the event as the state information.

15. An optical fiber sensing method by an optical fiber sensing device, the optical fiber sensing method comprising:
an output step of outputting pulsed light to one end of an optical fiber having one end connected to an optical network unit (ONU);
a receiving step of receiving backscattered light for the pulsed light from the one end of the optical fiber; and
a transmission step of transmitting state information indicating a state around the optical fiber based on the backscattered light.

16. The optical fiber sensing method according to claim 15, wherein in the transmission step, the state information is transmitted via a passive optical network (PON) line.

17. The optical fiber sensing method according to claim 16, wherein the optical fiber is the PON line.

18. The optical fiber sensing method according to claim 15, wherein the optical fiber is an optical fiber dedicated to sensing.

19. The optical fiber sensing method according to claim 15, wherein the optical fiber is laid so as to surround a periphery of a residential area of a building in which the ONU is provided.

20. The optical fiber sensing method according to claim 15, further comprising a step of acquiring sensing data indicating a state around the optical fiber based on the backscattered light,
wherein in the transmission step, the sensing data is transmitted as the state information.

21. (canceled)
